(19) United States
(12) Patent Application Publication
(10) Pub. No.: US 2004/0004083 A1
(43) Pub. Date: Jan. 8, 2004

(54) Hand held dispenser device

(76) Inventor: Bradford Grant, Bridgewater, NJ (US)

Correspondence Address: Darryl C. Little, Pfizer, Inc., 201 Tabor Road, Morris Plains, NJ, 07950, US

(21) Appl. No.: 10/191,352

(22) Filed: Jul. 8, 2002

(51) Int. Cl. A01C 1/00

(52) U.S. Cl. 221/185

(57) ABSTRACT

A dispenser device for storage and dispensing individual unit members of all types, including medicines, drugs, food and candy products. The units are held in a housing or container portion and released by a dispenser mechanism in a dispensing portion. A biased trigger member is operated in order to release the unit members from the housing portion. One or more finger positioners (depressed or raised configurations) are provided on the container portion, and the dispenser device is adapted to be positioned easily and comfortably in the user's hand. The trigger member is positioned such that it can be easily operated by one of the user's fingers.

### TECHNICAL FIELD

The present invention relates to hand-held dispenser devices for storage and dispensing of medicine, pills or tablets, candy units, and the like.

### BACKGROUND OF THE INVENTION

There are numerous devices known today which are used for the storage and dispensing of medicines, drugs, food and candy products. For medicines and drug products, it is often convenient to allow dispensing of the products one at a time or in a single dosage form. For food and candy products, it is often desirable to utilize a container or device which can be easily handled and stored, is sufficiently portable to be easily taken with the user, and can be disposable.

### SUMMARY OF THE INVENTION

It is an object of the present invention to provide a relatively small, easily portable dispenser device which can be used with medicines, drugs, small food items, candy products and the like. It is another object of the present invention to provide a relatively inexpensive and easy to use dispenser device which also can be disposable, if desired. It is also an object of the present invention to provide a dispenser device which allows easy release of the products in single dosage form.

In accordance with these objects, a unique and beneficial dispenser device is provided. The dispenser device includes a housing or container for storage of the products together with a mechanism for dispensing the products stored in the housing. The dispenser device can be reusable or disposable, depending on the needs of the user and supplier.

The dispenser device is provided of a size which fits easily and conveniently in a user's hand. One or more recesses or finger positioning means are provided along one side or edge of the dispenser device so that the device can be easily positioned in the user's hand and operated. A trigger or release mechanism is provided at one end of the dispenser device in order to allow release of the products stored therein. Preferably, a spring actuated sliding trigger mechanism is utilized which has a recess or pocket in which one of the products in the dispenser can be positioned for release.

The present invention can be used with any type of easily dispensable medicine, drug, small food items, candy products, and the like. The product can be in any form conventionally known today, such as pills, beads, tablets, and capsules, and can have any consistency, size and shape, such as a solid hard spherical product, a liquid-filled product, a gelatin capsule product, etc. Activation of the trigger mechanism allows release of one of the products stored in the dispenser device for use or consumption by the user. The housing can be made of a translucent material—or have viewing windows so that the amount of product remaining therein can be easily viewed.

### BRIEF DESCRIPTION OF THE DRAWINGS

The invention will be illustrated by the following description of various embodiments of the invention which are given by way of example only and are not deemed to be limiting.

FIG. 1 is a perspective view of a dispenser device in accordance with the present invention;

FIG. 2 is a side view of a preferred embodiment of the present invention with a portion broken away in order to illustrate a preferred release mechanism;

FIG. 3 is a partial view of a preferred dispenser device depicting the release mechanism when a product is being released from the device;

FIG. 4 illustrates a use of the present invention;

FIGS. 5 and 6 illustrate alternate embodiments of the present invention wherein different numbers of finger positioning recesses are provided;

FIG. 7 is an exploded view of an alternate embodiment of the present invention;

FIG. 8 illustrates still another alternate embodiment of the present invention; and

FIG. 9 illustrates still a further embodiment of the present invention.

### DESCRIPTION OF THE PREFERRED EMBODIMENT(S)

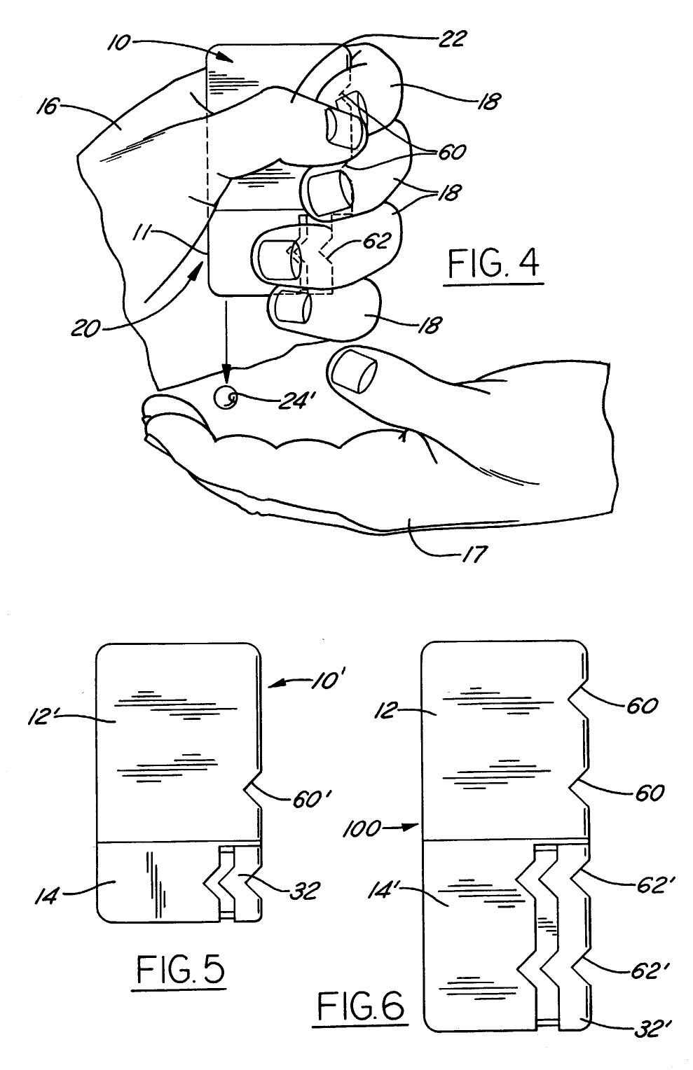

A preferred embodiment of the present invention is shown in FIGS. 1-4 and is referred to generally by the reference numeral 10. The dispenser device 10 includes a container or housing portion 12 and a dispensing or release mechanism portion 14. Preferably, the dispenser device 10 has a size and shape to fit comfortably within the palm of the user's hand. This is particularly shown in FIG. 4 where the user's hand 16 is shown comfortably holding the dispensing device 10 between several of the user's fingers 18 and a portion of the palm 20 of the user's hand adjacent the user's thumb 22.

The housing or container portion 12 is hollow and preferably made of an injection molded plastic material. The housing has a sufficient volume to hold a significant number of medicine tablets, drugs, pills, food, or candy beads 24 therein. In this regard, the products 24 can be of any conventional or convenient type. The products 24 can be medicine tablets, drug pills, capsules, or other drug-type products, solid or liquid-filled candy products or beads, semi-solid gel caps, micro capsules, or any other small and easily consumed products known today. For example, the products 24 could be small breath mints, whether solid or liquid-filled. For convenience, the individual products 24 will be referred to herein as “units,” although this term is not meant to be limiting in any regard.

Preferably, the units are provided of a easily dispensable shape, such as round, spherical, or oval so that the units can be easily dispensed by the dispensing mechanism from the device 10. The units also should be made of a material which, at least on the outside, remain sufficiently hard and relatively non-tacky at room temperatures or common environmental temperatures, so that the units can be easily dispensed from the device. The precise size and shape of the units is not significant with respect to the features of the invention and spherical units 24, 24′ are shown in the drawings for illustrative purposes only and is not meant to be limiting.

The dispensing portion 14 of the device 10 is also preferably made of a plastic material and is secured to the container or housing portion 12 in any convenient manner. For example, the two portions 12 and 14 can be snap-fitted together, or glued, heat staked or otherwise permanently affixed together. In addition, it is possible according to the present invention to provide a one-piece dispenser device 10 or to provide a device made from a larger number of portions or members, so long as the main objects and benefits of the present invention are obtained.

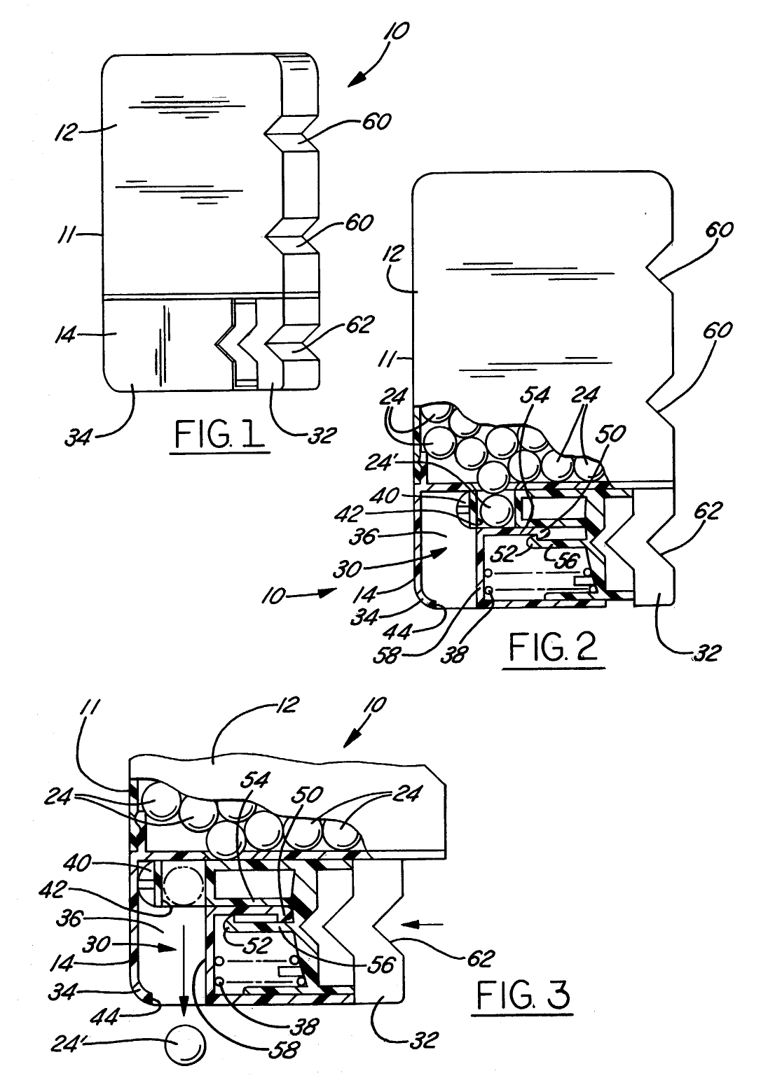

A preferred dispensing mechanism is shown in FIGS. 2 and 3 and referred to generally by the reference numeral 30. The dispensing mechanism 30 has a trigger member 32 which is slidingly received between a pair of outer shell or casing members 34 and 36.

The trigger member 32 is shown in its home or rest position in FIG. 2 and in its depressed and unit release position in FIG. 3. A biasing member, such as a small coil spring 38, is utilized to restore the trigger member 32 to its rest or home position after it is depressed, and a unit 24 is released. It is understood in accordance with the present invention that any conventional biasing means or mechanism can be used to bias the trigger member.

The trigger member 32 contains a slide member 40 which has a recess or pocket 42 therein and in which one of the units 24′ can be positioned. As shown in FIG. 2, the recess 42 can have a unit 24′ positioned in it when the trigger member is at its rest position. Then, as shown in FIG. 3, when the trigger member 32 is activated and forced against the pressure of the coil spring 38, the unit 24′ is allowed to be released from the pocket or recess 42 and dropped through opening 44 in the bottom of the dispenser device 10.

As shown in FIGS. 2 and 3, the dispensing mechanism 14 contains a number of wall members which allow the trigger member 32 to easily slide in the dispenser device 10 and at the same time prevent it from being easily removed from the device once it is assembled. For the latter purpose, a pair of mating hook members 50 and 52 are provided on wall members 54 and 56, respectively, which allow the trigger member to slide in one direction but prevent it from being removed from the device. Wall member 58 acts as a stop relative to the spring member 38 when it is compressed as the trigger member 32 is moved from the rest position to the dispensing position.

Also, as shown in FIGS. 1-4, the dispenser device 10 contains a number of finger positioning recesses 60 that are positioned in the housing or container portion 12. As particularly shown in FIG. 4, the finger receiving recesses 60 are situated and generally sized in order to allow the user's fingers 18 to be positioned in them and thus to easily and securely hold the dispenser device 10 in place in user's hand. In this regard, although two finger positioning recesses 60 are illustrated in FIGS. 1-4 in association with the preferred embodiment, it is also understood that a different number of finger positioning recesses could be provided in the dispenser device. In this regard, a dispenser device 10′ with a single finger positioning recess 60′ is shown in FIG. 5. It is also understood that a larger number of finger positioning recesses could be provided, such as three or more, if desired.

It is also possible for the trigger member 32 to have a surface or shape similar to a finger positioning recess in order to provide a comfortable fit in the user's hand and to permit easy operation of the device 10. Such a surface 62 is shown in FIGS. 1-4. In this manner, when the dispenser device 10 is positioned in the user's hand 16, as shown in FIG. 4, the index and middle fingers of the user's hand are positioned in the two finger positioning recesses 60, and the ring finger of the user's hand is positioned on the surface 62 on the trigger member 32. The opposite surface 11 of the dispenser device 10, that is, the surface 11 opposed to the finger positioning recesses 60, is also shaped and positioned to fit comfortably and snugly in the palm 20 of the user's hand, adjacent the user's thumb 22. The palm positioner can be curved, either convex or concave, recessed, raised or otherwise configured to fit comfortably and easily into the palm area adjacent a user's thumb.

It is also to be understood in accordance with the present invention that the finger positioner means on the dispenser device could be any raised configurations, such as a series of small bumps or ridges, etc. It is further to be understood that where finger positioning recesses are utilized, the recesses could have virtually any shape, such as triangular as shown in FIGS. 1-9, square, convex curved, and the like. In this regard, the particular finger positioning means shown in the drawings are only representative of all of the various shapes and configurations of raised or depressed configurations which can be utilized in accordance with the present invention, and are not meant to be limiting.

With the dispenser device 10 held in the position as shown in FIG. 4, the trigger member 32 can be easily operated by the user in order to allow dispensing of a unit 24′ into, for example, the other hand 17 of the user.

Another alternate embodiment of the present invention is shown in FIG. 6. In this embodiment, the dispenser device 100 has a pair of finger recesses 60 in the dispenser portion 12 and a pair of finger positioning surfaces 62′ in the trigger member 32′ of the dispensing mechanism portion 14′. In this manner, all four of the user's fingers can be utilized for holding and operating the dispenser device 100.

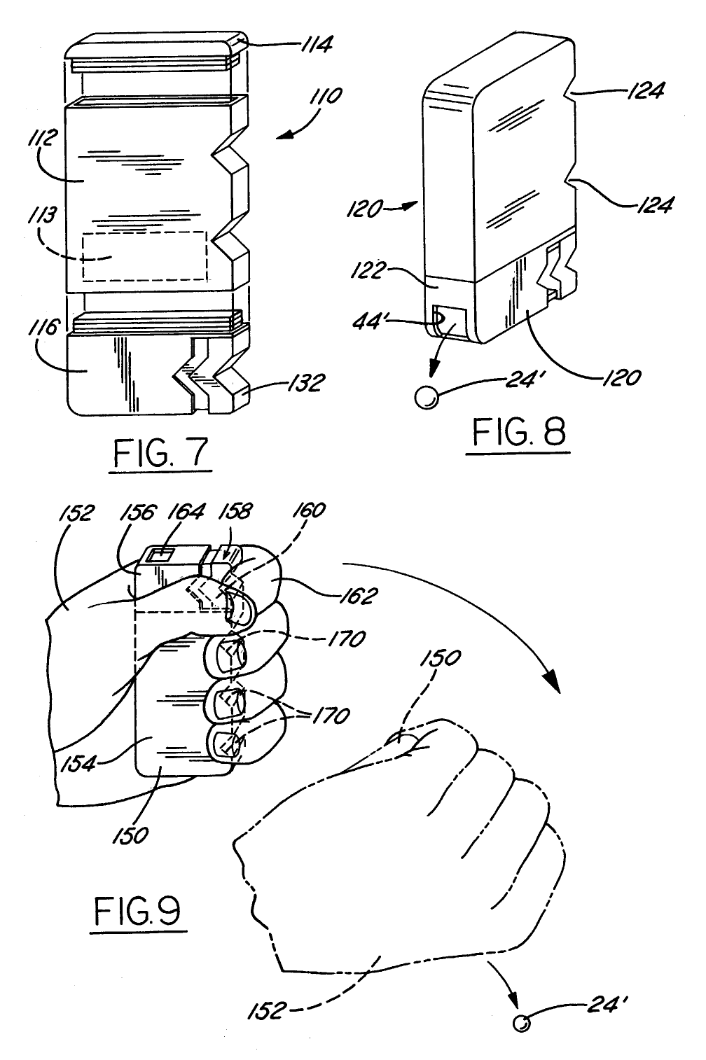

A further alternate version of the invention is shown in FIG. 7. In this embodiment, a dispensing device 110 is provided that can be refilled with units and reused. For this purpose, the storage or container portion 112 has a removable lid or top member 114 which can be removed so that the storage container or housing 112 can be refilled as desired. The container portion 112, in turn, is attached to the dispensing portion 116 in any conventional manner, such as those described above with reference to the embodiment shown in FIGS. 1-4. Preferably, the portions 112, 114 and 116 are snap-fitted together.

A still further embodiment of the present invention is shown in FIG. 8. In this embodiment 120, the opening 44′ for release of the units 24′ is in the surface 122 or portion of the dispenser device 120 opposite to the finger positioning recesses 124.

In the embodiments shown in FIGS. 1-8, the dispenser devices are adapted to be positioned and held in the manner shown in FIG. 4, namely with the storage container holding the units in a vertically upward position, and the dispensing portion and trigger member in a vertically lower position. In this manner, the units can be dropped directly downwardly into the other hand of the user.

In accordance with the present invention, however, the dispenser device can be either utilized in the opposite orientation, or provided so that it can be utilized in an opposite orientation. This is shown in FIG. 9 wherein a dispenser device 150 is shown positioned in a user's hand 152.

In the FIG. 9 embodiment, the dispenser device 150 has the housing or storage portion 154 positioned vertically below the dispensing portion 156 which includes the dispensing mechanism 158 (not shown). In this embodiment, the trigger member 160 is adapted to be positioned adjacent to and operated by the index finger 162 of the user's hand 152. Once a unit is positioned in the pocket or recess in the dispensing mechanism, a slight depression or operation of the trigger member 160 allows the unit to be in position for release from the dispenser device 150. Once the trigger member 160 is fully depressed, the dispenser device in the user's hand can be inverted in order to allow the unit to drop through opening 164 and into the user's mouth or opposite hand.

It is also noted in FIG. 9 that three finger positioning recesses 170 are provided in the housing or container portion 154. This allows grasp of the dispensing device 150 by three fingers of the user, namely the middle, ring, and little fingers. Again, the dispensing device 150 is provided of such a size and shape such that it fits easily and comfortably in the palm of the user's hand.

All of the portions of the dispensing devices described above are preferably made of a plastic material. The only exception possibly being the use of a metal coil spring member 38 if such a biasing device of that type was utilized in the invention. Suitable plastic materials which can be used in the present invention include, for example, polystyrene, polypropylene, ABS, polyethylene, acetyl, nylon and the like. The plastic material is preferably injection molded in the shapes shown and snap-fit or affixed together as indicated above. In addition, the plastic material provided can be made from a transparent or opaque material, and can be provided in any appropriate color. If desired, the housing or container members utilized with the dispenser device can be provided of a transparent material so that the user can view the amount of units remaining in the device. It is also possible to provide one or more windows in an opaque or non-transparent housing for the same purpose. (A window 113 is shown, for example, in dispenser 110 in FIG. 7.)

Preferably, the dispenser devices are made of an inexpensive plastic material allowing the products to be disposable and simply thrown away when the units are exhausted. In this manner, the dispensers can be sold with a full complement of units and be simply disposed of when the supply of units is exhausted.

While particular embodiments of the invention have been shown and described, numerous variations and alternative embodiments will occur to those skilled in the art. Accordingly, it is intended that the invention be limited only in terms of the appended claims.

What is claimed is:

1. A dispenser device for storing and dispensing unit members comprising:
a housing having first and second opposed narrow side walls, an upper end, a lower end, first and second opposed broad side walls and a central storage cavity therein for storing a plurality of unit members;
a dispensing mechanism adjacent said lower end for individually dispensing unit members from said housing;
said dispensing mechanism having an activation member moveable between a dispensing position allowing release of unit members from said housing and a rest position preventing release of unit members from said housing;
said housing having an outer configuration adapted to fit comfortably in a user's hand between the user's fingers and the palm of the user's hand; and
said housing having at least one finger positioner on said first opposed narrow side wall adapted for placement of at least one of the user's fingers when the dispensing device is held in a user's hand.

2. The dispenser device as set forth in claim 1 wherein said activation member slidingly moves between the dispensing position and the rest position.

3. The dispenser device as set forth in claim 1 wherein said dispensing mechanism has a bottom surface and wherein unit members can be dispensed from the dispenser device through said bottom surface.

4. The dispenser device as set forth in claim 3 further comprising an opening in said bottom surface for dispensing of the unit members.

5. The dispenser device as set forth in claim 1 wherein two finger positioners are provided on said first opposed narrow side wall.

6. The dispenser device as set forth in claim 1 wherein three finger positioners are provided on said first opposed narrow side wall.

7. The dispenser device as set forth in claim 1 wherein said finger positioner comprises a recess in said first narrow side wall.

8. The dispenser device as set forth in claim 1 wherein said finger positioner comprises a raised member on said first narrow side wall.

9. The dispenser device as set forth in claim 1 further comprising a finger positioner on said activation member.

10. The dispenser device as set forth in claim 1 wherein said housing and said dispensing mechanism are releasably attached together.

11. The dispenser device as set forth in claim 1 wherein said housing and said dispensing mechanism are snap-fit together.

12. The dispenser device as set forth in claim 1 wherein said housing and said dispensing mechanism are securely affixed together.

13. The dispenser device as set forth in claim 1 further comprising a detachable cap member positioned on said upper end of said housing thereby facilitating replacement of unit members in said central storage cavity.

14. The dispenser device as set forth in claim 1 further comprising palm registration means on said second opposed narrow side wall.

15. The dispenser device as set forth in claim 1 further comprising a biasing member biasing said activation member to said rest position.

16. The dispenser device as set forth in claim 15 wherein said biasing member is a coil spring member.

17. The dispenser device as set forth in claim 1 wherein said dispensing mechanism has a rear surface adjacent said bottom surface and wherein unit members can be dispensed from the dispenser device through said rear surface.

18. A dispenser device for dispensing small members comprising:
a housing, said housing having a storage portion for storing a plurality of small members and a dispensing portion for dispensing the small members from said housing, said dispensing position having an opening for egress of the small members from the dispenser, said housing having first and second opposed outer surfaces and being sized to fit comfortably in a user's hand;
said first opposed outer surface having at least one positioner for placement of at least one finger of a user's hand;
said second opposed outer surface being adapted for placement in the palm of a user's hand;
an activation member in said dispensing portion and moveable between a first position blocking said opening thereby preventing egress of the members from the dispenser device and a second position allowing egress of the members from the dispenser device; and
said activation member adapted for movement between said first and second positions by at least one finger of the user's hand.

19. The dispenser device as set forth in claim 18 wherein said activation member slidingly moves between said first and second positions.

20. The dispenser device as set forth in claim 18 wherein said dispensing mechanism has a bottom surface and wherein small members can be dispensed from the dispenser device through said bottom surface.

21. The dispenser device as set forth in claim 18 further comprising an opening in said bottom surface for dispensing of small members.

22. The dispenser device as set forth in claim 18 wherein two finger positioners are provided on said first opposed narrow side wall.

23. The dispenser device as set forth in claim 18 wherein three finger positioners are provided on said first opposed narrow side wall.

24. The dispenser device as set forth in claim 18 further comprising a finger positioner on said activation members.

25. The dispenser device as set forth in claim 18 wherein said finger positioner comprises a recess in said first opposed outer surface.

26. The dispenser device as set forth in claim 18 wherein said finger positioner comprises a raised member on said first opposed outer surface.

27. The dispenser device as set forth in claim 18 wherein said housing and said dispensing mechanism are releasably attached together.

28. The dispenser device as set forth in claim 18 wherein said housing and said dispensing mechanism are snap-fit together.

29. The dispenser device as set forth in claim 18 wherein said housing and said dispensing mechanism are securely affixed together.

30. The dispenser device as set forth in claim 18 further comprising a detachable cap member positioned on said upper end of said housing thereby facilitating replacement of unit members in said central storage cavity.

31. The dispenser device as set forth in claim 18 further comprising a palm positioner on said second opposed narrow side wall.

32. The dispenser device as set forth in claim 18 further comprising a biasing member biasing said activation member to said rest position.

33. The dispenser device as set forth in claim 32 wherein said biasing member is a coil spring member.

34. The dispenser device as set forth in claim 18 wherein said dispensing mechanism has a rear surface adjacent said bottom surface and wherein unit members are dispensed from the dispenser device through said rear surface.

35. A method for dispensing individual unit members from a dispensing device, comprising the steps of:
(a) providing a dispensing device comprising:
(i) a housing having first and second opposed narrow side walls, an upper end, a lower end, first and second opposed broad side walls and a central storage cavity therein for storing a plurality of unit members;
(ii) a dispensing mechanism adjacent said lower end for individually dispensing unit members from said housing;
(iii) said dispensing mechanism having an activation member moveable between a dispensing position allowing release of unit members from said housing and a rest position preventing release of unit members from said housing;
(iv) said housing having an outer configuration adapted to fit comfortably in a user's hand between the user's fingers and the palm of the user's hand; and
(v) said housing having at least one finger positioner on said first opposed narrow side wall adapted for placement of at least one of the user's fingers when the dispensing device is held in a user's hand;
(b) placing said dispensing device in the palm of a user's hand wherein one of the user's fingers is positioned in said at least one finger positioner and another of the user's fingers is positioned on said activation member; and
(c) depressing said activation member and releasing one of the unit members from said dispensing device.

36. The method for dispensing unit members as set forth in claim 35 wherein the unit member is released through the bottom of the dispensing mechanism.
